(19) United States
(12) Patent Application Publication
(10) Pub. No.: US 2004/0237407 A1
(43) Pub. Date: Dec. 2, 2004

(54) Gate bracket containing cushioning material

(76) Inventor: Geoffrey John KREUTZER, Hazelden, QLD (AU)

Correspondence Address: Don W Bulson Esq, Renner Otto Boisselle & Sklar LLP, 1621 Euclid Avenue, 19th Floor, Cleveland, OH, 44115, US

(21) Appl. No.: 10/490,012

(22) PCT Filed: Sep. 13, 2002
(86) PCT No.: PCT/AU02/01266

(51) Int. Cl. E06B 11/02

(52) U.S. Cl. 49/50

(57) ABSTRACT

A gate bracket (10) for a gate (36) of the type which can swing between a closed position and an open position, the gate bracket having attachment means (11) to enable the gate bracket to be attached adjacent a gate and an elongate cushioning member (12) which in use extends at least partially over the forward vertical edge (21) of the gate, when the gate is in the open position.

### FIELD OF THE INVENTION

This invention is directed to a gate bracket which has a cushioning member and which can be attached to a horseracing starting gate. The invention is however not limited to this precise use and the gate bracket may be attachable to other types of gates or barriers to provide protection to animals.

### BACKGROUND ART

In the sport of horseracing, horses are held in a starting gate prior to the commencement of the race. The starting gate is a structure which has a pair of spaced apart side barriers between which the horse is positioned. The front of the structure is provided with a pair of outwardly hinging exiting gate members which are opened to start the race. The rear of the starting gate has a pair of entry gate members through which the horse passes prior to the race beginning. The side barriers extend slightly forwardly of each entry gate member such that when the entry gate member is hinged to the open position, it lies against this forward part of the side barrier. An example of this type of gate member is illustrated in the left-hand two gates of FIG. 6. However, the gate member is longer than the forward part of the side barrier which means that the gate member, when in the open position, extends past the forward part.

A typical starting gate can have between 5-20 sets of gate members to hold a similar number of horses prior to a race.

Many horses are nervous when in or around the starting gate structure, and is found that the horse, jockey or barrier attendants can injure themselves on the forward end of each gate member.

It is known to stretch padding material about the entry gate members in order to reduce injury. For instance, such padding material is illustrated in FIGS. 7-9. The padding material extends only over the smooth inner wall of the gate but cannot extend over the outer wall of the gate member as the outer wall contains operating arm members and the like which operate the gate members between the closed position and the open position.

### OBJECT OF THE INVENTION

It is an object of the invention to provide a gate bracket which can be attached adjacent the entry of a starting gate and which can minimise or at least partially reduce possible injury to a horse, rider or barrier attendants, and aid in the easier access of passing an animal into the starting gate.

It is a further object of the invention to provide a gate bracket which may overcome at least some of the abovementioned disadvantages or provide the public with a useful or commercial choice.

In one form, the invention resides in a gate bracket for a gate member of the type which can swing between a closed position and an open position the gate member having an outer vertical edge, the gate bracket comprising attachment means to enable the gate bracket to be attached adjacent the gate member and an elongate cushioning member which, in use, extends at least partially over the forward vertical edge of the gate, when the gate member is in the open position, the cushioning member remaining fixed in place when the gate member swings between the closed position and the open position

The attachment means may comprise one or more frame members which is/are adapted for attachment to a support member to which the gate is supported for swinging movement.

The elongate cushioning member may comprise a resilient elongate member having a substantially D shaped cross-section which defines a curved outer face and a substantially planar inner face, the inner face extending at least partially over the forward vertical edge of the gate when the gate is in the open position.

The gate bracket may include one or more gate holders to hold the gate in the open position. These can be in the form of spring-loaded catches.

The gate bracket can be designed to be attached to the forward portion of a starting gate, basically to extend the forward portion sufficiently such that the cushioning member can overlie the vertical front edge of each gate member. Of course, this design is suitable for a starting gate but the design may be different if the gate bracket is used on a different type of gate.

The gate bracket is particularly designed for a swinging gate which can swing between a closed position and an open position where the gate is typically at between 45 degrees-90 degrees relative to the closed position.

The gate bracket has attachment means to allow it to be attached relative to a gate. Typically, the gate bracket is not attached directly to the gate and does not swing with the gate. Instead, the gate bracket is attached typically next to the gate such that when the gate is swung into an open position, the hard edge of the gate is protected by the cushioning member.

This can be achieved in many ways depending on the type of gate and how the gate is swingingly attached. However, it is usual for the gate to be swingingly attached to some sort of post member or support member, and it is envisaged that the gate bracket will be attached to all relative to the post member or support member as this would be a convenient point of attachment.

The attachment means typically comprises one or more frame members. The frame members may comprise elongate metal members such as arm members. The frame members are typically required to ensure that the cushioning member or cushioning means can extend in front of the front edge of the gate when the gate is swung into an open position. The length and size of the frame members will therefore vary depending on the length and size of the gate.

The cushioning member may comprise a resilient rubber fender which is typically substantially D shaped in cross-section. The fender preferably extends at least partially along the front edge of the gate, but it is considered that it may not be essential for the fender to extend entirely along the front edge of the gate. It is found that having the fender extending from adjacent an upper part of the gate to at least halfway down the gate may be sufficient to protect against injury to a horse/rider or any other animal which will pass through the gate.

The cushioning member may therefore have a length of between 20-60 cm. The cushioning member may also have a width or thickness of between 5-30 cm.

### BRIEF DESCRIPTION OF THE DRAWINGS

An embodiment of the invention will be described with reference to the following drawings in which:

FIG. 1. Illustrates a gate bracket according to an embodiment of the invention in elevation.

FIG. 2. Illustrates the gate bracket of FIG. 1 in front view.

FIG. 3. Illustrates the gate bracket of FIG. 1 in rear view.

FIG. 4. Illustrates the gate bracket of FIG. 1 in plan view.

FIG. 5. Illustrates the gate bracket of FIG. 1 attached to a gate member in elevation.

FIG. 6. Illustrates a plan view of a starting gate having 5 barriers 1-5 with barrier 1 being completely free from the gate bracket according to the invention.

### BEST MODE

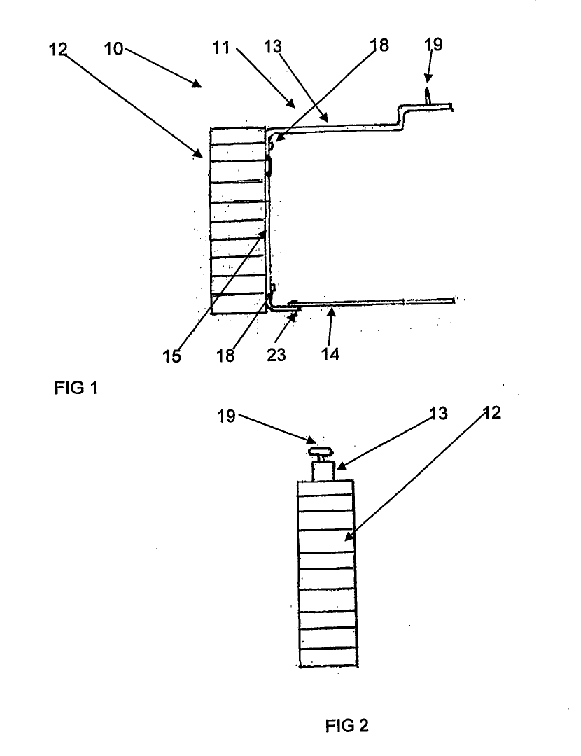

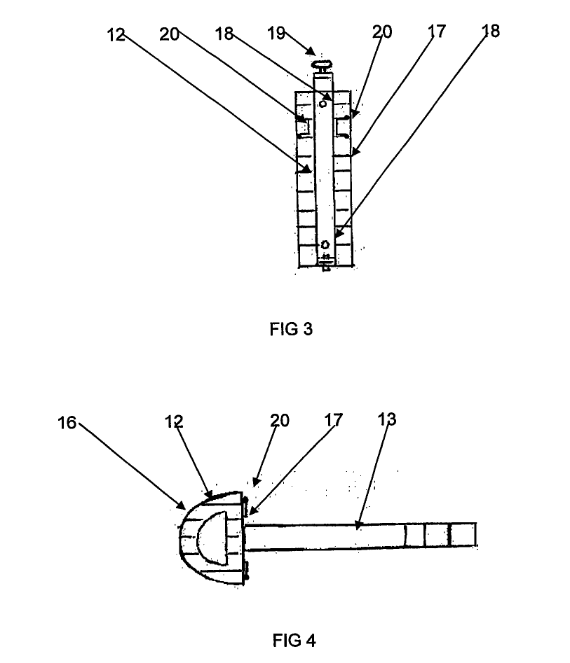

Referring to the figures and initially to FIGS. 1-4 there is illustrated a gate bracket 10 for use with a starting gate. Gate bracket 10 includes attachment means 11, and a vertically extending elongate cushioning member 12.

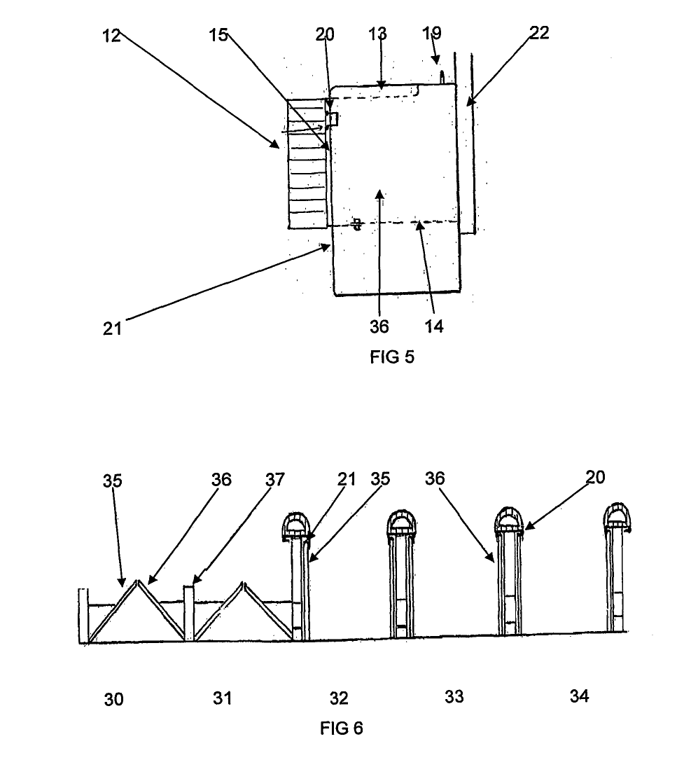

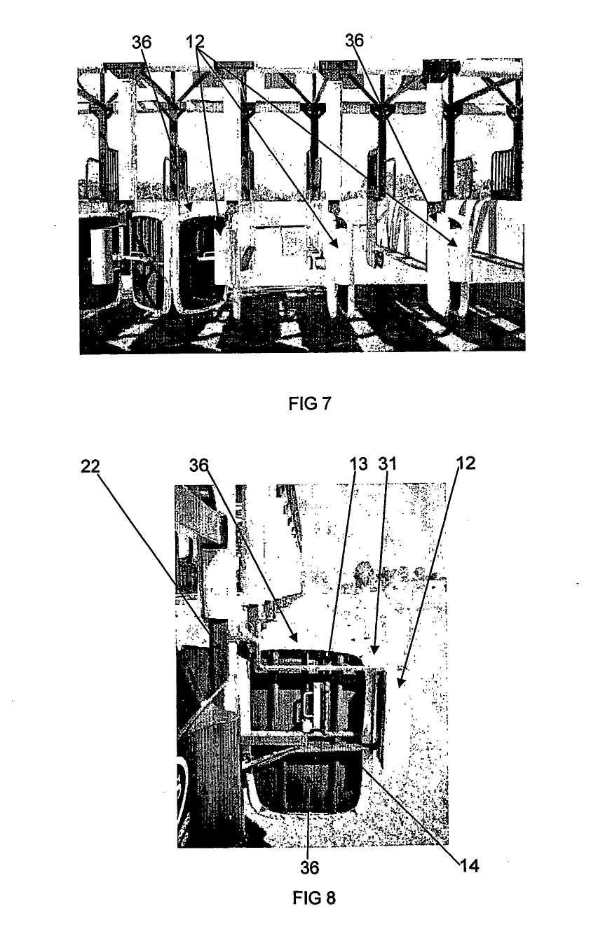

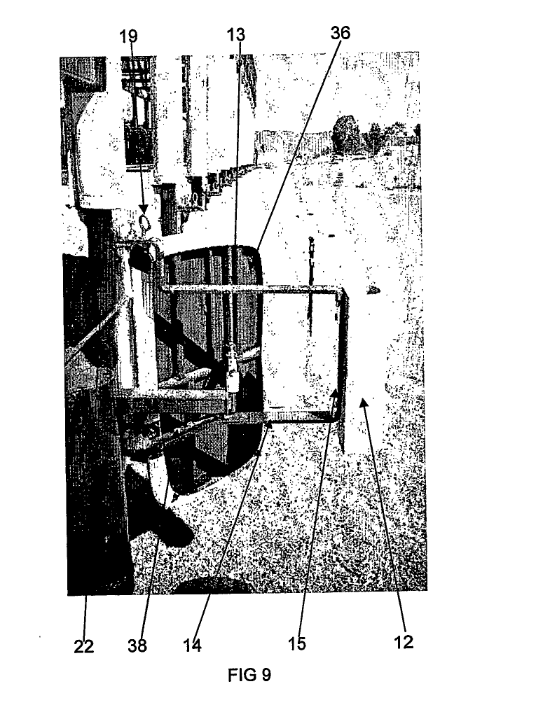

Gate bracket 10 is attachable to a support but is not attached directly to the gate member which swings between a closed position and an open position. FIG. 6 is a plan view of 5 barrier gates of 30-34, each barrier gates having a pair of swinging gate members 35, 36 which can swing between a closed position illustrated in barrier gates 30 and 31 and an open position illustrated in barrier gates 32-34.

Gate bracket 10 in the embodiment includes attachment means in the form of an upper substantially horizontal frame member 13, a lower substantially horizontal frame member 14 and a front substantially vertical frame member 15. These frame members may be formed separately and attached to each other, or may comprise a unitary structure which is bent to shape.

Gate bracket 10 includes a vertically extending elongate cushioning member 12. In the embodiment, cushioning member 12 is a rubber D fender, this being best illustrated in FIG. 4. Member 12 therefore has a curved outer face 16 (see FIG. 4) and a substantially planar inner face 17. Member 12 is hollow which facilitates the cushioning ability of the member. Member 12 can have a length and thickness which can vary depending on the size of gate etc, but typically has a length of between 20-100 cm and a thickness (i.e. from inner face 17 to the outermost part of the curved outer face 16) of between 10-40 cm. Member 12 is attached to vertical frame member 15 and this can be achieved using fasteners 18 or any other type of suitable attachment means.

Attached to upper frame member 13 is a short vertical pin or projection 19 which functions as a strap keeper to allow one end of a guiding strap (not illustrated) to be attached to the strap keeper. The guiding strap is known and is used to guide a horse or other animal through the open gate members.

To enable the gate members to be held in the open position, the rear or inner face 17 of cushioning member 12 supports a gate holder in the form of a small spring-loaded catch 20. A pair of catches 20 are provided which extend to each side of vertical frame member 15, this being best illustrated in the rear view of the gate bracket illustrated in FIG. 3. By having a pair of catches 20, a single gate bracket can hold open a pair of adjacent gate members as will be described in greater detail with reference to FIG. 6.

Referring to FIG. 5, this illustrates attachment of the gate bracket relative to a gate member 36. Gate member 36 typically comprises a metal or other type of gate which is substantially rectangular in shape and has a forward vertical edge 21 which can injure an animal, rider or barrier attendant or can be a snag point. The gate bracket is attached to or relative to a vertical post member 22 (of course any other type of convenient support member could also be used). The frame members 13, 14 are sufficiently long to ensure that the vertical cushioning member 12 extends forwardly of vertical edge 21 of gate member 36. If necessary, the frame members 13, 14 may be length adjustable, and if necessary, vertical frame member 15 may also be height adjustable. As illustrated in FIG. 1, lower frame member 14 is attached to vertical frame member 15 through bolt or other suitable fastener 23.

Referring to FIG. 6, there is illustrated a plan view of a barrier gate assembly which comprises five barrier gates 30-34 each having a pair of swinging gate members 35, 36. The barrier gate assembly is known and forms no part of the invention per se. Each barrier gate 30-34 has an intervening short forward portion 37, however it can be seen that forward portion 37 is not long enough to extend in front of the front vertical edge 21 of each gate member. Barrier gate 30 is an unmodified barrier gate which is known in the industry. However, barrier gates 32, 33 and 34 are provided with the gate bracket which forms part of the invention. It can be seen that gate members 35 and 36 of barrier gates 32 and 33 are in the open position and the front vertical edges are protected by being positioned underneath the inner face 17 of vertical cushioning member 12. Gate members 35, 36 are held in this open position by the gate catches 20. Therefore, when the gate members are in the open position, there is little or no likelihood of the gate members injuring and animal, a horse/rider combination or barrier attendant or presenting a snag point or injury point.

The gate bracket can be readily attached to a barrier gate, and once attached can stay in position for as long as required.

FIGS. 7-9 illustrate photographs of the gate bracket attached to a starting gate. The gate bracket is attached to the rear entry gates of the horse racing starting gate. FIG. 9 best illustrates an embodiment of the invention showing how upper frame member 13 has one end attached to post 22 while lower frame member 14 is attached to an extended bracket arrangement 38 which forms part of the starting gate door operating mechanism. Thus, the gate bracket can be easily retrofitted to existing starting gates.

It should be appreciated that various other changes and modifications may be made to the embodiment described without departing from the spirit and scope of the invention as claimed.

1. A gate bracket for a gate member of the type which can swing between a closed position and an open position the gate member having an outer vertical edge, the gate bracket comprising attachment means to enable the gate bracket to be attached adjacent the gate member and an elongate cushioning member which, in use, extends at least partially over the forward vertical edge of the gate, when the gate member is in the open position, the cushioning member remaining fixed in place when the gate member swings between the closed position and the open position.

2. The bracket as claimed in claim 1 wherein the attachment means comprises one or more frame members which adapted for attachment to a support member relative to which the gate is supported for swinging movement.

3. The bracket as claimed in claim 2 wherein the elongate cushioning member comprises a resilient elongate member.

4. The bracket as claimed in claim 3, wherein the resilient elongate member has a substantially D shaped cross-section which defines a curved outer face and a substantially planar inner face, the inner face extending at least partially over the outer edge of the gate when the gate is in the open position.

5. The bracket as claimed in claim 4, wherein the bracket includes one or more gate holders to hold the gate in the open position.

6. The bracket as claimed in claim 4, wherein the resilient member has a length of between 20-60 cm.

7. The bracket as claimed in claim 6, wherein the resilient member has a width of between 5-30 cm.
